(19) United States
(12) Patent Application Publication
(10) Pub. No.: US 2025/0121328 A1
(43) Pub. Date: Apr. 17, 2025

(54) PARTICULATE FILTER CONNECTING STRUCTURE OF EXHAUST GAS POST PROCESSING SYSTEM

(71) Applicants: HYUNDAI MOTOR COMPANY, Seoul (KR); KIA CORPORATION, Seoul (KR)

(72) Inventors: Chang Dae KIM, Hwaseong-si (KR); Jong Suk KIM, Hwaseong-si (KR)

(73) Assignees: HYUNDAI MOTOR COMPANY, Seoul (KR); KIA CORPORATION, Seoul (KR)

(21) Appl. No.: 18/818,240

(22) Filed: Aug. 28, 2024

(30) Foreign Application Priority Data
Oct. 11, 2023 (KR) 10-2023-0135237

(51) Int. Cl. B01D 53/94

(52) U.S. Cl. CPC B01D 53/9477; B01D 2271/02; B01D 2279/30

(57) ABSTRACT

A particulate filter connecting structure of an exhaust gas post processing system that engages flanges provided in a particulate filter and catalyst devices adjacent to the particulate filter through a clamp is provided. The particulate filter connecting structure includes a gasket interposed between the flanges and is formed with a bead portion curved convexly into a round shape.

### CROSS-REFERENCE TO RELATED APPLICATION

This application claims priority to and the benefit of Korean Patent Application No. 10-2023-0135237 filed in the Korean Intellectual Property Office on Oct. 11, 2023, the entire contents of which are incorporated herein by reference.

### TECHNICAL FIELD

The present disclosure relates to an exhaust gas post processing system. In particular, the present disclosure relates to a particulate filter connecting structure of an exhaust gas post processing system.

### BACKGROUND

Generally, commercial vehicles are equipped with an exhaust gas post processing system that purifies exhaust gas exhausted from the engine.

This exhaust gas post processing system may include, for example, an oxidation catalyst (or catalyst converter), particulate filter, and selective catalytic reduction.

Here, the particulate filter is disposed between the oxidation catalyst and selective catalytic reduction, and can be engaged with the oxidation catalyst and selective catalytic reduction through the engage unit.

The engage unit is designed to connect flanges of cast steel castings provided at adjacent connection ends of the particulate filter, oxidation catalyst, and selective catalytic reduction through clamps.

Furthermore, the engage unit is equipped with a gasket disposed between neighboring flanges. In one example, the gasket may be composed of a combination of two bead plates and an inner plate disposed between the two bead plates.

Recently, the structure of the flange and gasket has been changed to improve the assembly productivity of the exhaust gas post processing system and the sealing performance between neighboring flanges.

The matters described in this background art section are written to enhance understanding of the background of the disclosure, and may include matters that are not prior art already known to those skilled in the art in the field to which this technology belongs.

### SUMMARY

The present disclosure seeks to provide a particulate filter connecting structure of an exhaust gas post processing system to improve sealing performance and assemble productivity.

At least one aspect of the present disclosure provides a particulate filter connecting structure of an exhaust gas post processing system that engages flanges provided in a particulate filter and other catalyst devices adjacent to the particulate filter through a clamp, the particulate filter connecting structure according to an exemplary embodiment may include a gasket interposed between the flanges and formed with a bead portion curved convexly into a round shape.

The gasket may include at least one clip holder that extends in a rib shape from an outer edge and is bent to surround one of the flanges.

The at least one clip holder may be exposed to the outside of the clamp between the flanges.

Another aspect of the present disclosure provides a particulate filter connecting structure of an exhaust gas post processing system according to an exemplary embodiment may include a first flange that is provided in any one of a particulate filter or one of catalyst devices adjacent to the particulate filter and is formed in a convex shape, a second flange provided in another one of the particulate filter or one of the catalyst devices adjacent to the particulate filter, and formed in a flare shape corresponding to one inclined plane of the first flange, a gasket that is interposed between the first flange and the second flange and has a round-shaped bead portion, and a clamp that engages the first flange and the second flange.

The gasket may be provided in the shape of a single plate ring.

The gasket may form a plurality of sealing lines in contact with the first flange and the second flange by elastic deformation of the bead portion.

The gasket may include at least one clip holder extends in a rib shape from an outer edge and is bent to surround the first flange.

The at least one clip holder may include a mounting part extending from the outer edge of the gasket to the other inclined plane of the first flange, and a bend portion bent in the forward and backward directions of the particulate filter in the mounting part. The bend portion may be exposed to the outside of the clamp.

The gasket may further include BN coating layers formed on both sides.

The first flange may include a ‘V’ or ‘U’ shaped convex portion with inclined planes on both sides, and the second flange may include a flare portion of an inclined plane shape corresponding to one inclined plane of the convex portion.

The first flange may include at least one notch formed at the edge, and the second flange may include an embossed protrusion that engages the at least one notch.

According to embodiments of the present disclosure, the cost and weight of the exhaust gas post processing system can be reduced, assemble productivity can be improved, and the sealing performance and assemble quality of the particulate filter can be secured.

In addition, the effects that can be obtained due to the embodiments of the present disclosure will be disclosed directly or implicitly in the detailed description of the embodiments of the present disclosure. That is, various effects obtained according to embodiments of the present disclosure will be disclosed in the detailed description.

### BRIEF DESCRIPTION OF THE DRAWINGS

Since these drawings are for reference in explaining exemplary embodiments of the present disclosure, the technical idea of the present disclosure should not be interpreted as limited to the attached drawings.

FIG. 1 is a drawing showing an exhaust gas post processing system to which a particulate filter connecting structure of an exhaust gas post processing system according to an exemplary embodiment may be applied.

FIG. 2 is a perspective view showing the particulate filter connecting structure of an exhaust gas post processing system according to an exemplary embodiment.

FIG. 3 is an exploded perspective view showing the particulate filter connecting structure of an exhaust gas post processing system according to an exemplary embodiment.

FIG. 4 is a cross-sectional view showing the particulate filter connecting structure of an exhaust gas post processing system according to an exemplary embodiment.

FIG. 5 is a perspective view showing a gasket applied to the particulate filter connecting structure of an exhaust gas post processing system according to an exemplary embodiment.

FIG. 6 is a perspective view showing a clip holder of the gasket applied to the particulate filter connecting structure of an exhaust gas post processing system according to an exemplary embodiment.

FIG. 7A and FIG. 7B are drawings showing mount states of the gasket applied to the particulate filter connecting structure of an exhaust gas post processing system according to an exemplary embodiment.

FIG. 8 is a cross-sectional view showing the gasket applied to the particulate filter connecting structure of an exhaust gas post processing system according to an exemplary embodiment.

FIG. 9 is a drawing showing a flange applied to the particulate filter connecting structure of an exhaust gas post processing system according to an exemplary embodiment.

The drawings referenced above are not necessarily drawn to scale, but should be understood as presenting a somewhat simplified representation of various features illustrating the basic principles of the present disclosure. The specific design features of the disclosure, including, for example, specific dimensions, orientation, location, and shape, will be determined in part by the particular intended application and usage environment.

### DETAILED DESCRIPTION

Hereinafter, with reference to the attached drawings, embodiments of the present disclosure will be described in detail so that those skilled in the art can easily implement the present disclosure. As those skilled in the art would realize, the described embodiments may be modified in various different ways, all without departing from the spirit or scope of the present disclosure.

The terminology used herein is for the purpose of describing specific embodiments only and is not intended to limit the disclosure. As used herein, singular forms are intended to also include plural forms, unless the context clearly indicates otherwise.

As used herein, the terms ‘comprise’ and/or ‘comprising’ indicate the presence of specified features, integers, steps, operations, elements and/or components, but may also include one or more other features, integers or steps. It should also be understood that this does not exclude the presence or addition of elements, operations, components, and/or groups thereof.

As used herein, the term ‘and/or’ includes any one or all combinations of one or more items listed in association.

In this specification, the term ‘connected’ indicates a physical relationship between two components in which the components are directly connected to each other by welding, rivets, SPR (Self Piercing Rivet), FDS (Flow Drill Screw), structural adhesive, etc., or indirectly connected through one or more intermediate components.

As used herein, ‘vehicle’, ‘vehicular’, ‘automobile’ or other similar terms as used herein generally refer to passenger vehicles, including sports cars, sport utility vehicles (SUVs), buses, trucks, and various other similar terms including various commercial vehicles.

Hereinafter, exemplary embodiments of the present disclosure will be described in detail with reference to the accompanying drawing.

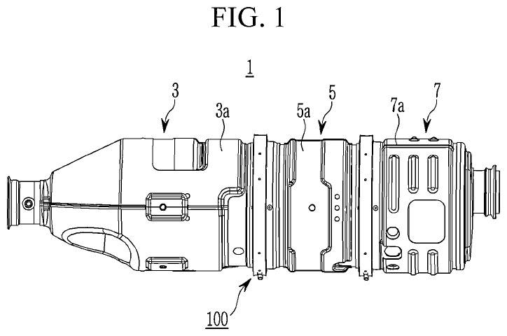

FIG. 1 is a drawing showing an exhaust gas post processing system to which a particulate filter connecting structure of an exhaust gas post processing system according to an exemplary embodiment may be applied.

Referring to FIG. 1, a particulate filter connecting structure 100 according to an exemplary embodiment, for example, may be applied to an exhaust gas post processing system 1 of a commercial vehicle.

The exhaust gas post processing system 1 is connected to an exhaust manifold (not shown) of an engine and is configured to purify or filter harmful materials in the exhaust gas exhausted from the exhaust manifold. In one example, the engine may include a diesel engine.

Here, the exhaust gas post processing system 1 includes a plurality of converter devices (e.g., catalyst devices) connected to each other along the stream direction (e.g., forward and backward directions) of the exhaust gas.

For example, the exhaust gas post processing system 1 may include an oxidation catalyst converter 3, a particulate filter 5, and a selective catalytic reduction 7.

The oxidation catalyst converter 3 is configured to remove HC and CO from the engine's exhaust gas and to increase the temperature of the exhaust gas through oxidation reaction during fuel injection.

The particulate filter 5 physically collects soot in the exhaust gas and may be periodically regenerated using the heat of the exhaust gas.

The selective catalytic reduction 7 is configured to remove nitrogen oxide (NOx) in the purified or filtered exhaust gas through the oxidation catalyst converter 3 and the particulate filter 5.

The particulate filter 5 may be placed between the oxidation catalyst converter 3 and the selective catalytic reduction 7.

The particulate filter 5 may be connected to the oxidation catalyst converter 3 and the selective catalytic reduction 7 by the particulate filter connecting structure 100 of an exhaust gas post processing system 1 according to an exemplary embodiment.

The particulate filter 5 is separated from the oxidation catalyst converter 3 and the selective catalytic reduction 7 by the particulate filter connecting structure so that periodic ash cleaning may be performed.

Hereinafter, the oxidation catalyst converter 3 and the selective catalytic reduction 7, respectively disposed in the front and rear (e.g., forward and backward) directions of the particulate filter 5, are referred to as other catalyst devices 3 and 7 for ease of understanding.

The particulate filter connecting structure 100 of an exhaust gas post processing system 1 according to an exemplary embodiment is configured to engage the particulate filter 5 with other neighboring catalyst devices 3 and 7 or to separate the particulate filter 5 from other catalyst devices 3 and 7.

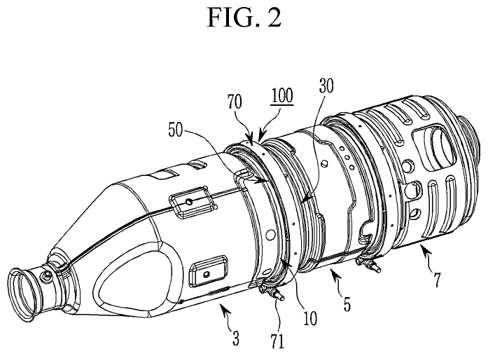

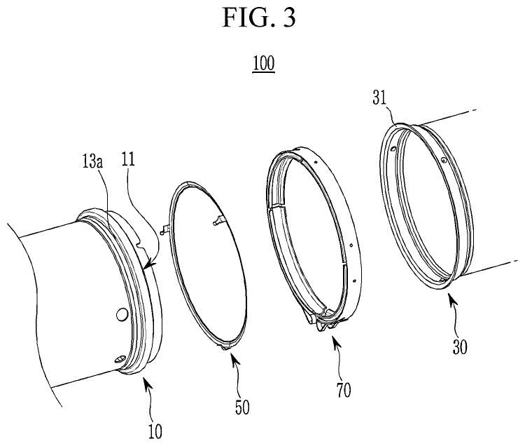

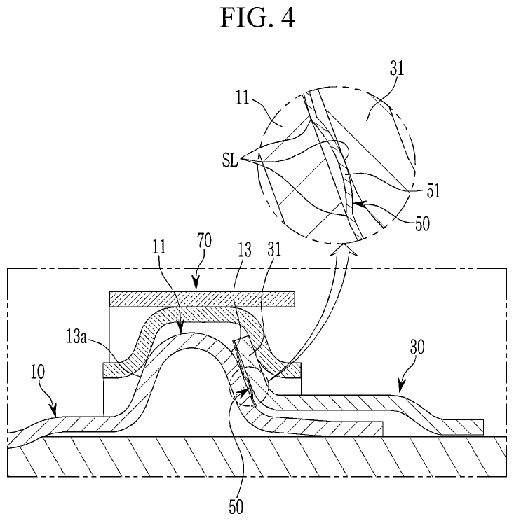

FIG. 2 is a perspective view showing the particulate filter connecting structure of an exhaust gas post processing system according to an exemplary embodiment, FIG. 3 is an exploded perspective view showing the particulate filter connecting structure of an exhaust gas post processing system according to an exemplary embodiment, and FIG. 4 is a cross-sectional view showing the particulate filter connecting structure of an exhaust gas post processing system according to an exemplary embodiment.

Referring to FIGS. 1-4, the particulate filter connecting structure 100 of an exhaust gas post processing system 1 according to an exemplary embodiment may include a first flange 10, a second flange 30, a gasket 50, and a clamp 70.

In an exemplary embodiment, the first flange 10 may be provided in any one of the particulate filter 5 or the other catalyst devices 3 and 7 adjacent to the particulate filter 5.

For example, the first flange 10 may be provided in the oxidation catalyst converter 3 adjacent to particulate filter 5. Further, the first flange 10 may be provided at one end of a catalyst housing 3a of the oxidation catalyst converter 3.

However, the exemplary embodiment of the present disclosure is not limited to this, and the first flange 10 may be provided at one end of a filter housing 5a of the particulate filter 5 adjacent to a catalyst housing 7a of the selective catalytic reduction 7.

However, hereinafter, for convenience of understanding, the first flange 10 provided at one end of catalyst housing 3a in the oxidation catalyst converter 3 will be explained as an example.

The first flange 10 may be formed by forming a cast steel plate (e.g., beading forming).

In one example, the first flange 10 may be molded directly into one end of the catalyst housing 3a of the oxidation catalyst converter 3. In another example, the first flange 10 may be molded separately and fixed (e.g., welded) to one end of the catalyst housing 3a.

The first flange 10 includes a convex portion 11 of a convex shape, for example, a ‘V’ or ‘U’ shape. In the convex portion 11, inclined planes 13 and 13a are formed on both sides, respectively.

In an exemplary embodiment, the second flange 30 may be clamped with the first flange 10. The second flange 30 may be provided to another one of the particulate filter 5 or other catalyst devices 3 and 7 adjacent to the particulate filter 5.

For example, the second flange 30 may be provided to the particulate filter 5. Further, the second flange 30 may be provided at the other end of the filter housing 5a of the particulate filter 5, in a position corresponding to the first flange 10.

In the exemplary embodiment of the present disclosure, it is not limited to this, and the second flange 30 may be provided at one end of the catalyst housing 7a of the selective catalytic reduction 7 adjacent to the particulate filter 5.

However, hereinafter, the second flange 30 provided at the other end of the filter housing 5a in the particulate filter 5 will be explained as an example.

The second flange 30 may be formed by forming a cast steel plate.

In one example, the second flange 30 may be molded separately and fastened (e.g., welded) to the other end of the filter housing 5a of the particulate filter 5. In another example, the second flange 30 may be molded directly into the other end of filter housing 5a of the particulate filter 5.

The second flange 30 includes a flare portion 31. For example, the flare portion 31 of an inclined plane shape can correspond to one inclined plane 13 of the convex portion 11 of the first flange 10.

In an exemplary embodiment, the gasket 50 is configured to seal between the first flange 10 and the second flange 30.

The gasket 50 may be a ring shape of a single plate (e.g., a 0.5t steel thin plate). The gasket 50 is interposed between the first flange 10 and the second flange 30. The gasket 50 is interposed between the inclined plane 13 on one side of the convex portion 11 and the flare portion 31.

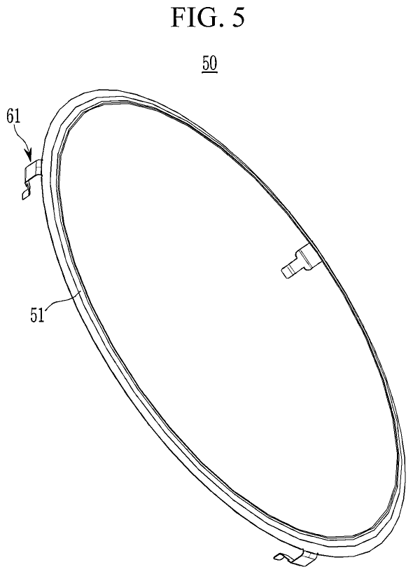

FIG. 5 is a perspective view showing a gasket applied to the particulate filter connecting structure of an exhaust gas post processing system according to an exemplary embodiment.

Referring to FIGS. 2-5, the gasket 50 includes a bead portion 51 and at least one clip holder 61.

The bead portion 51 is protruded into a round shape along the circumferential direction of the gasket 50 so as to contact the flare portion 31 of the second flange 30. The bead portion 51 is formed in a convexly curved shape, and its shape may be elastically changed by compressing the first flange 10 and the second flange 30.

Accordingly, the gasket 50 forms a plurality of sealing lines SL in contact with the first flange 10 and the second flange 30 by elastically modified or deformed shape of the bead portion 51, and may seal between the first flange 10 and the second flange 30.

The at least one clip holder 61 is configured to fix (e.g., hold) the gasket 50 between the first flange 10 and the second flange 30. Also, the at least one clip holder 61 is configured to check for missing installation of the gasket 50.

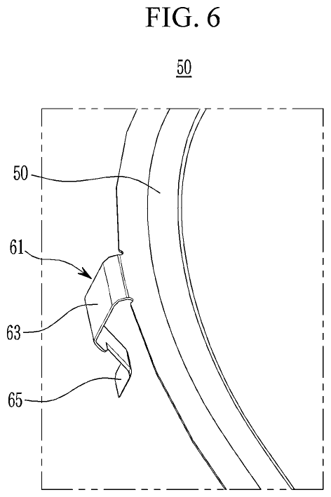

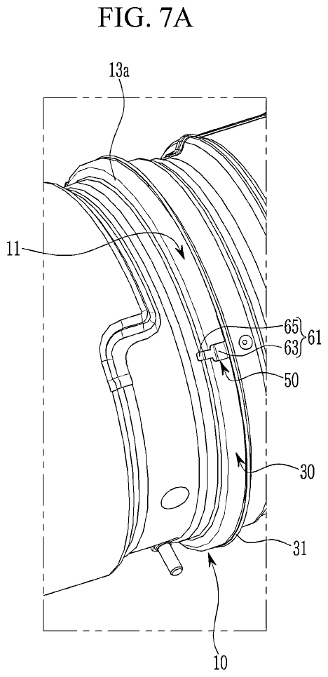

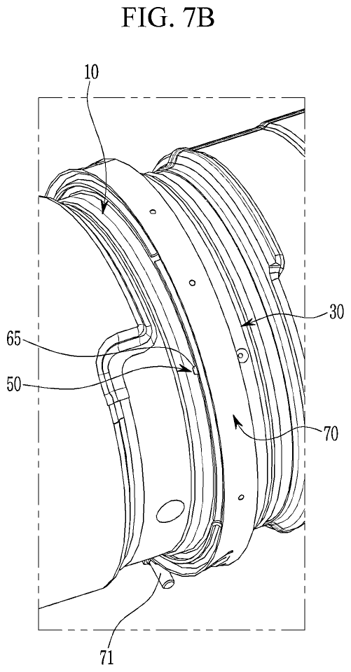

FIG. 6 is a perspective view showing a clip holder of the gasket applied to the particulate filter connecting structure of an exhaust gas post processing system according to an exemplary embodiment, and FIG. 7A and FIG. 7B are drawings showing mount states of the gasket applied to the particulate filter connecting structure of an exhaust gas post processing system according to an exemplary embodiment.

Referring to FIGS. 5-7B, the at least one clip holder 61 extends in a rib shape from an outer edge of the gasket 50.

The at least one clip holder 61 may be provided in a bent shape to surround the convex portion 11 of the first flange 10.

And, the at least one clip holder 61 may be exposed between the first flange 10 and the second flange 30 to the outside of the clamp 70, which will be explained later.

The at least one clip holder 61 includes a mounting part 63 and a bend portion 65.

The mounting part 63 extends from the outer edge of the gasket 50 to the other inclined plane 13a of the convex portion 11 in a direction to surround the convex portion 11 of the first flange 10.

The mounting part 63 may fix (e.g., mount) the gasket 50 to the convex portion 11 of the first flange 10 between the first flange 10 and the second flange 30.

The bend portion 65 is bent in the front and rear (e.g., forward and backward) direction of particulate filter 5 from the mounting part 63. The bend portion 65 may be exposed to the outside of the clamp 70, which will be explained later.

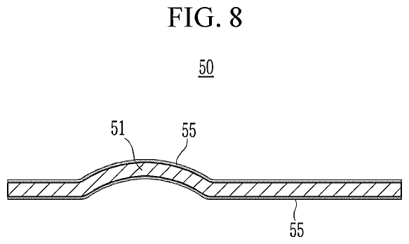

FIG. 8 is a cross-sectional view showing the gasket applied to the particulate filter connecting structure of an exhaust gas post processing system according to an exemplary embodiment.

As shown in FIG. 8, the gasket 50 further includes at least one Boron Nitride (BN) coating layers 55 formed on both sides.

The BN coating layer 55 may maximize the sealing effect between the first flange 10 and the second flange 30 even when the surfaces of the first flange 10 and the second flange 30 have not been treated (e.g., surface polished).

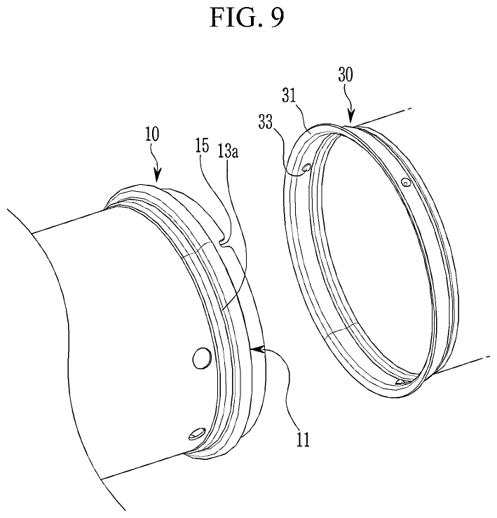

FIG. 9 is a drawing showing a flange applied to the particulate filter connecting structure of an exhaust gas post processing system according to an exemplary embodiment.

As shown in FIG. 9, the first flange 10 according to an exemplary embodiment may further include at least one notch 15 formed at the edge.

The at least one notch 15 may be formed in the form of a chamfered groove at the edge of the first flange 10.

And, the second flange 30 may further include an embossed protrusion 33. The embossed protrusion 33 may engage at least one notch 15. This embossed protrusion 33 is formed on the inside of the second flange 30 in the radial direction.

The at least one notch 15 and embossed protrusion 33 are combined with each other when the first flange 10 and the second flange 30 are engaged, and are configured to prevent relative rotation of the particulate filter 5 and other catalyst devices 3 and 7.

Referring to at least FIG. 2, in an exemplary embodiment, the clamp 70 is configured to engage or separate the first flange 10 and the second flange 30 with the gasket 50 in between.

In one example, the clamp 70 may be provided as a band type with a ‘V’ shaped cross-section to surround the first flange 10 and the second flange 30. For example, the clamp 70 also is sometimes referred to as a ‘V clamp’.

The clamp 70 surrounds the first flange 10 and the second flange 30 and may be engaged by an engage bolt 71.

Hereinafter, the operation of the particulate filter connecting structure 100 of an exhaust gas post processing system 1 according to an exemplary embodiment configured as described above will be described in detail, referring to FIG. 1 to FIG. 9.

The particulate filter 5, and other catalyst devices 3 and 7 to be engaged with the particulate filter 5, are equipped with the first flange 10 and the second flange 30, respectively.

The gasket 50 including the bead portion 51 and at least one clip holder 61 is provided, and the V type clamp 70 is provided.

In this state, the gasket 50 is placed between the first flange 10 and the second flange 30, and the first flange 10 and the second flange 30 are combined along the forward and backward directions.

The first flange 10 and the second flange 30 are joined along a longitudinal direction through at least one notch 15 and the embossed protrusion 33. Accordingly, the particulate filter 5 and other catalyst devices 3 and 7 may be provisionally assembled without rotation at a predetermined position.

One side of the gasket 50 is in contact with one inclined plane 13 of the convex portion 11 of the first flange 10, and the other side of the gasket 50 is in contact with the flare portion 31 of the second flange 30 through the bead portion 51.

At least one clip holder 61 of the gasket 50 surrounds the convex portion 11 of the first flange 10 through the mounting part 63 and is mounted on the first flange 10.

Accordingly, by mounting at least one clip holder 61 on the first flange 10, it is possible to prevent the gasket 50 from being separated between the first flange 10 and the second flange 30.

Then, the clamp 70 surrounds the first flange 10 and the second flange 30 and clamps the first flange 10 and the second flange 30.

Then, the clamp 70 compresses the first flange 10 and the second flange 30, and as a result, the bead portion 51 of the gasket 50 is elastically deformed to form a plurality of sealing lines SL in contact with the first flange 10 and the second flange 30.

Therefore, the gasket 50 may seal between the first flange 10 and the second flange 30. Because the gasket 50 has the BN coating layers 55 formed on both sides, the sealing effect between the first flange 10 and the second flange 30 may be maximized even when the surfaces of the first flange 10 and the second flange 30 are not treated.

A portion of the gasket 50, the bend portion 65 of at least one clip holder 61, is exposed to the outside of the clamp 70. Accordingly, a worker may check whether the mount of gasket 50 is missing.

As a result, particulate filter 5 may engage with other neighboring catalyst devices 3 and 7 through a series of processes as described above.

Meanwhile, in order to perform periodic ash cleaning of the particulate filter 5, the particulate filter 5 can be separated from other catalyst devices 3 and 7 by releasing the clamp 70.

According to the particulate filter connecting structure 100 of an exhaust gas post processing system 1 according to an exemplary embodiment, the first flange 10 and the second flange 30 may be formed by a casting method of a cast steel plate.

According to the particulate filter connecting structure 100 of an exhaust gas post processing system 1 according to an exemplary embodiment, the thin plate gasket 50 is placed between the first flange 10 and the second flange 30, and the first flange 10 and the second flange 30 are clamped through the clamp 70 and the particulate filter 5 may be engaged with other catalyst devices 3 and 7.

Furthermore, according to the particulate filter connecting structure 100 of an exhaust gas post processing system 1 according to an exemplary embodiment, the gasket 50 is formed with the bead portion 51 and at least one clip holder 61 is applied.

Therefore, according to the particulate filter connecting structure 100 of an exhaust gas post processing system 1 according to an exemplary embodiment, the first flange 10 and the second flange 30 are constructed with a cast steel plate forming method (e.g., unlike constructing the flange with a cast steel casting molding). Accordingly, the cost and weight of the exhaust gas post processing system can be reduced and assemble productivity can be improved.

In addition, according to the particulate filter connecting structure 100 of an exhaust gas post processing system 1 according to an exemplary embodiment, the sealing performance of the first flange 10 and the second flange 30 can be secured by the bead portion 51 of the gasket 50 and the BN coating layers 55.

Furthermore, according to the particulate filter connecting structure 100 of an exhaust gas post processing system 1 according to an exemplary embodiment, when assembling the particulate filter 5, the gasket 50 is connected between the first flange 10 and the second flange 30 through at least one clip holder 61.

Accordingly, when assembling the particulate filter 5, the gasket 50 can be prevented from being separated between the first flange 10 and the second flange 30.

Furthermore, according to the particulate filter connecting structure 100 of an exhaust gas post processing system 1 according to an exemplary embodiment, at least one clip holder 61 of the gasket 50 interposed between the first flange 10 and the second flange 30 can be exposed to the outside of the clamp 70.

Therefore, the missing mount of the gasket 50 can be confirmed, and thus the quality of the assembly of the particulate filter 5 can be secured.

While embodiments of this disclosure have been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. A particulate filter connecting structure of an exhaust gas post processing system that engages flanges provided in a particulate filter and catalyst devices adjacent to the particulate filter through a clamp, the particulate filter connecting structure comprising:
a gasket interposed between the flanges and formed with a bead portion curved convexly into a round shape.

2. The particulate filter connecting structure of claim 1, wherein the gasket comprises at least one clip holder that extends in a rib shape from an outer edge and is bent to surround one of the flanges.

3. The particulate filter connecting structure of claim 2, wherein the at least one clip holder is exposed to an outside of the clamp between the flanges.

4. A particulate filter connecting structure of an exhaust gas post processing system comprising:
a first flange that is provided in any one of a particulate filter or one of a plurality of catalyst devices adjacent to the particulate filter and the first flange is formed in a convex shape;
a second flange provided in another one of the particulate filter or one of the catalyst devices adjacent to the particulate filter, and the second flange is formed in a flare shape corresponding to one inclined plane of the first flange;
a gasket that is interposed between the first flange and the second flange and has a round-shaped bead portion; and
a clamp that engages the first flange and the second flange.

5. The particulate filter connecting structure of claim 4, wherein the gasket is provided in the shape of a single plate ring.

6. The particulate filter connecting structure of claim 4, wherein the gasket forms a plurality of sealing lines in contact with the first flange and the second flange by elastic deformation of the bead portion.

7. The particulate filter connecting structure of claim 4, wherein the gasket comprises at least one clip holder extending in a rib shape from an outer edge and is bent to surround the first flange.

8. The particulate filter connecting structure of claim 7, wherein the at least one clip holder comprises:
a mounting part extending from the outer edge of the gasket to another inclined plane of the first flange; and
a bend portion bent in forward and backward directions of the particulate filter in the mounting part.

9. The particulate filter connecting structure of claim 8, wherein the bend portion is exposed to the outside of the clamp.

10. The particulate filter connecting structure of claim 4, wherein the gasket further comprises BN coating layers formed on both sides.

11. The particulate filter connecting structure of claim 4, wherein:
the first flange includes a ‘V’ or ‘U’ shaped convex portion with inclined planes on both sides; and
the second flange includes a flare portion of an inclined plane shape corresponding to at least one inclined plane of the convex portion of the first flange.

12. The particulate filter connecting structure of claim 4, wherein:
the first flange includes at least one notch formed at an edge; and
the second flange includes an embossed protrusion that engages the at least one notch.
